(19) United States
(12) Patent Application Publication
(10) Pub. No.: US 2006/0163529 A1
(43) Pub. Date: Jul. 27, 2006

(54) Water-based coolant fluid for engine applications

(75) Inventor: Janne Jokinen, Espoo (FI)

Correspondence Address: BIRCH STEWART KOLASCH & BIRCH, PO BOX 747, FALLS CHURCH, VA, 22040-0747, US

(73) Assignee: Neste Oil Oyj, Espoo (FI)

(21) Appl. No.: 10/533,880

(22) PCT Filed: Oct. 29, 2003
(86) PCT No.: PCT/FI03/00802

§ 371 Date: Dec. 30, 2005

Related U.S. Application Data
(60) Provisional application No. 60/424,716, filed on Nov. 8, 2002.

(30) Foreign Application Priority Data
Nov. 8, 2002 (FI) 20022004

(51) Int. Cl. C09K 5/00

(52) U.S. Cl. 252/73

(57) ABSTRACT

The invention relates to the use of an aqueous solution comprising trimethyl glycine as a coolant fluid in engine applications selected from engines used in automobiles, trucks, motorcycles, aircrafts, trains, tractors, generators, compressors, from stationary engines and equipment, marine engines, power systems, industrial engines, electric engines, fuel cell engines and hybride engines.

### FIELD OF INVENTION

The present invention relates to a water-based coolant fluid containing trimethyl glycine for engine applications, such as engines commonly used in automobiles, trucks, motorcycles, aircrafts, trains, tractors, generators, compressors, for various stationary engine and equipment applications, marine engine applications and the like wherein cooling systems are used.

### BACKGROUND OF INVENTION

The primary role of a coolant fluid is to remove heat and thus cool the engine. The fluid operates in a closed loop system. To provide efficient cooling the fluid must have a high specific heat and thermal conductivity and low viscosity at operating temperatures which generally may vary in the range of −40° C.-+120° C. Typically internal combustion engines operate at approximately +95° C. The fluid must keep the engine operational also at subfreezing temperatures and provide maximum freeze protection.

Normal pressure boiling point elevation is also a beneficial property of the fluid in engine coolant applications. Enabling the coolant to remove more heat can be achieved by increasing the system pressure and thus the boiling point of the coolant which allows the coolant to circulate at a higher maximum temperature.

Another important property of coolants is the corrosion protection they provide. Automotive heat exchangers and their construction are well known in the art. They contain elastomeric materials, rigid polymeric materials and multiple metals including aluminium, aluminium alloys, steel, cast iron, brass, solder and copper all of which may with time be dissolved in the working coolant composition within a cooling system by physical abrasion and chemical action. Automotive manufacturers have tried to reduce car weight to improve fuel efficiency by increasing the use of aluminium in engines.

During operation of the heat transfer system many factors, particularly elevated temperatures and contaminants may accelerate corrosion and because corrosion is an oxidative process the most critical factor is the amount of oxygen in the system. In glycol systems oxygen accelerates the oxidative degradation of the glycol to form corrosive acids. For light-duty automotive applications where the engine operates intermittently, the corrosion inhibitors must protect the system during operation and while idle. Film-forming silicates are widely used for corrosion protection of heat-emitting aluminium surfaces but they have the disadvantage of reducing the heat-transfer efficiency of the coolant, and they react with time with the glycol and any salts to form gels which may cause engine failure.

Cavitation corrosion is a phenomenon which relates particularly to modern thin-walled automotive engines containing aluminium, particularly to aluminium cylinder liners and water-pumps which are exposed constantly to aqueous systems such as internal combustion engine coolants. Pitting of aluminium surfaces can be detected and further, corrosion products and deposits can interfere with heat transfer. Overheating and engine failure from thermal related stress are possible.

Commercially available engine coolants are generally mixtures of various chemical components and an alcohol, the preferred alcohols being selected from the group consisting of ethylene glycol, diethylene glycol, propylene glycol, dipropylene glycol and mixtures thereof. Usually coolants contain mainly ethylene glycol because of foaming tendency of other alcohols, and other components comprise water and additional chemical compound which provide corrosion protection. Said glycols bring about corrosion problems, produce unpleasant odour and they are rather toxic and they must be treated as hazardous waste.

Engine coolants containing inorganic components like silicates, phosphates, nitrates, borates and nitrites have problems due to inhibition depletion. The depletion of these components, particularly the silicates have led to concerns about lifetime. High solids loading from inorganic salts presents potential deposit issues. The precipitating solids may scale and plug passages within the engine coolant systems.

Engine coolants based primarily on carboxylic acid technology have been developed. A combination of a monobasic or a dibasic carboxylic acid and a triazole are used in combination with other optional additives. Triazoles are required usually for the protection of yellow metals such as copper, brass and solder.

Several methods have been proposed for improving properties of engine coolants. A combination of water soluble phosphate with tungstate, selenate and molybdate for the protection against cavitation corrosion of aluminium is proposed in U.S. Pat. No. 4,548,787.

U.S. Pat. No. 4,404,116 teaches the use of polyhydric alcohols as corrosion inhibiting and cavitation reducing additives for coolants.

U.S. Pat. No. 4,440,721 discloses the combination of a water-soluble phosphate with a water-soluble molybdate, tungstate and selenate for providing a protective effect against the cavitation corrosion of aluminium in aqueous liquids.

WO 00/50532 proposes a monocarboxylic acid based antifreeze composition for diesel engines. Said formulation comprises a combination of a mixture of ethylene or propylene glycol, a monobasic aliphatic organic acid, azoles, low levels of molybdates, a combination of nitrite and/or nitrate salts, polyvinylpyrrolidone, a hydroxide salt, silicates and/or siloxane stabilized silicates with transition metal compounds which provide a protective effect against the cavitation corrosion of aluminium in aqueous liquids.

WO 97/31988 discloses a non-toxic heat transfer/cooling fluid containing trimethyl glycine and water for solar panels, refrigeration equipment, ventilation and air-conditioning equipment and heat pumps.

It can be seen that the prevention of cavitation corrosion, particularly of aluminium in engine applications is a difficult task. Efforts have been made in the state of art to solve the problem by the use of alkylene glycol based formulations and dicarboxylic acid based formulations with heavy loads of additives. Said formulations result often in high solid contents, they are expensive and cause environmental problems when discarded. Based on the above it can be seen that there exists a need for a stable, non-toxic, water-based, non-glycol containing coolant fluid for engine applications with superior corrosion protection and particularly improved inhibition of cavitation corrosion of aluminium.

### OBJECT OF THE INVENTION

An object of the invention is to provide a water-based efficient, stable, environmentally acceptable non-toxic coolant fluid for engine applications with improved cavitation corrosion prevention properties.

A further object of the invention is the use of a water-based trimethyl glycine containing fluid as a coolant for engine applications.

The characteristic features of the coolant fluid and its use are provided in the claims.

### SUMMARY OF THE INVENTION

It has been discovered that an aqueous solution containing trimethyl glycine, also known as betaine, or salts or derivatives thereof, may be used as a coolant fluid in various engine applications, such as engines commonly used in automobiles, trucks, motorcycles, aircrafts, trains, tractors, generators, compressors, in stationary engine and equipment applications, in marine engine applications, in power systems, in industrial engines, in electric engines, in fuel cell engines and in hybride engines and the like wherein cooling systems are used, and particularly in internal combustion engines in automobiles.

### DETAILED DESCRIPTION OF THE INVENTION

The coolant fluid according to the invention containing trimethyl glycine or salts or derivatives thereof may suitably be used at temperatures ranging between −40-+120° C. According to the invention, said water based coolant fluid comprises trimethyl glycine as an anhydrate or monohydrate, or salts of trimethyl glycine such as hydrochloride, or derivatives of trimethyl glycine such as dimethyl glycine, or mixtures thereof. Trimethyl glycine monohydrate is the preferable compound. Trimethyl glycine, or betaine, may for instance be produced synthetically or by extracting from natural sources like sugar beets, thus enabling the production of the water-based coolant fluid of biological origin having a favourable life cycle.

According to the invention, the coolant fluid useful in engine applications comprises 1 to 60% by weight, preferably 20 to 55% by weight of trimethyl glycine as an anhydrate or monohydrate, or salts or derivatives of trimethyl glycine or mixtures thereof, and 40 to 99% by weight, preferably 45 to 80% by weight of water. The water used in said coolant fluid compositions is suitably ion exchanged water or tap water of drinking water quality, preferably ion exchanged water.

The coolant according to the invention performs well even without any additives, which can be seen from the examples, but in cases where there are special requirements for engine coolant fluids, additives known in the art can be used. However, the amount of additives required is significantly below the amounts used in the coolants according to the state of the art.

Additives are selected taking into account the intended object of use of the coolant and the compatibility of the chemical compounds. Additives, such as stabilizers, corrosion inhibitors, agents for adjusting the viscosity, surface tension and pH, common in water based engine coolants, may if desired be added to the coolant fluid. Especially, compounds not harmful to the environment are used. Examples of commonly used additive/inhibitor mixtures are XLI and AFB from company Chevron Texaco and additive/inhibitor mixture BAYHIBIT from company Bayer. Some suitable additives are presented in the following.

Antiabrasion agents reduce abrasion of metal components. Examples of conventional antiabrasion agents are zinc dialkyl thiophosphate and zinc diaryl dithiophosphate. Typical antiabrasion agents also include metal or amine salts of organic sulphur, phosphorus or boron derivatives, or of carboxylic acids. As examples, salts of aliphatic or aromatic C₁-C₂₂-carboxylic acids, salts of sulphurous/sulphuric acids such as aromatic sulphonic acids, phosphorous/prosphoric acids, acid phosphate esters and analogous sulphurous/sulphuric compounds, e.g. thiophosphoric and dithiophosphoric acids, may be mentioned.

Corrosion inhibitors, also known as anticorrosion agents, reduce the destruction of metal components in contact with the coolant fluid. Examples of corrosion inhibitors include phosphosulphurated hydrocarbons and products obtained by reacting a phosphosulphurated hydrocarbon with an alkaline earth metal oxide or hydroxide. Further, agents preventing metals from corroding may also include organic or inorganic compounds such as metal nitrites, hydroxylamines, neutralized fatty acid carboxylates, phosphates, sarcosines and succinimides, etc. Amines such as alkanol amines, e.g. ethanol amine, diethanol amine and triethanol amine are suitable. Aromatic triazoles may be mentioned as examples of corrosion inhibitors of non-iron metal type.

A surface active agent, either non-ionic, cationic, anionic or amphoteric one, may be incorporated into the composition. Examples of suitable surface active agents include linear alcohol alkoxylates, nonyl phenol ethoxylates, fatty acid soaps, amine oxides, etc.

Antifoam agents may be used to control foaming. Foaming may be controlled with high molecular weight dimethyl siloxanes and polyethers. Silicone oil and polydimethyl siloxane are some examples of antifoam agents of polysiloxane type.

Detergents and antirust agents for metals include metal salts of sulphonic acids, alkyl phenols, sulphurized alkyl phenols, alkyl salisylates, naphtenates and other oil soluble mono- and dicarboxylic acids. Very basic metal salts like very basic alkaline earth metal sulphonates (particularly Ca and Mg salts) are often used as detergents.

As examples of suitable viscosity controlling agents, all kinds of agents known in the field for this purpose like polyisobutylene, copolymers of ethylene and propylene, polymetacrylates, metacrylate copolymers, copolymers of unsaturated dicarboxylic acid and a vinyl compound, interpolymers of styrene and acrylic esters, and partly hydrogenated styrene/isopropylene, styrene/butadiene and isoprene/butadiene copolymers as well as partly hydrogenated homopolymers of butadiene and isoprene, respectively, may be mentioned.

Antioxidants include alkaline earth metal salts of alkyl phenol thioesters preferably having C₅-C₁₂-alkyl side chains, e.g. calcium nonyl phenol sulphide, barium octyl phenyl sulphide, dioctyl phenyl amine, phenyl alphanaphtyl amine, phosphosulphurized or sulphurized hydrocarbons, etc.

Frictional properties of the coolant fluid may be controlled by means of agents for adjusting friction. Examples of suitable agents for adjusting friction include fatty acid esters and amides, molybdenum complexes of polyisobutenyl succinic anhydride amino alkanols, glycerol esters of dimerized fatty acids, alkane phosphonic acid salts, phosphonate combined with oleamide, S-carboxy alkylene hydrocarbyle succinimide, N-(hydroxyalkyl)-alkenyl succinamic acids or succinimides, di(lower alkyl) phosphites and epoksides, as well as alkylene oxide addition products of phosphosulphurated N-(hydroxyalkyl) alkenyl succinimides.

Suspension of insoluble matter present in the coolant fluid during use is assured with dispersing agents, thus preventing the slurry from flocculating and precipitating or depositing on metal parts.

Mineral oils act as swelling agents for sealing means, and accordingly, they have a swelling effect on the sealing means of the equipment. They include aliphatic C₈-C₁₃ alcohols such as the tridecyl alcohol.

The coolant fluid may also contain other additional components such as agents for extreme boundary lubrication, additives resisting high pressures, dyes, perfumes, antimicrobial agents and similar agents familiar to those skilled in the art.

The coolant fluid according to the invention has several advantages. It prevents cavitation corrosion surprisingly well also on aluminium surfaces, the foaming of the coolant is insignificant and the coolant is chemically and thermally very stable which results in that there is no need to replace it frequently. The possible degradation products of trimethyl glycine, if any, are not corroding compounds. On the contrary, glycol based coolants are usually changed every two to five years and/or inhibitors are added because glycol degrades and the degradation products are corrosive compounds. The coolant fluid according to the invention is non-toxic and as such it may not require hazardous waste treatment when discarded.

Table I below compares the toxicity of trimethyl glycine with that of ethylene glycol and propylene glycol based on LD₅₀ values found in the literature. The LD₅₀ values used are tested orally in rats.

TABLE I

| | LD₅₀/mg/kg |
|---|---|
| Ethylene glycol | 4 700 |
| Propylene glycol | 20 000 |
| Trimethyl glycine | 11 200 |

Much less additives are needed if any, when compared with conventional coolant fluids. Further, additives compatible with trimethyl glycine but incompatible with glycol based coolants, can be used in the coolant fluid according to the invention. Table IIa shows the effect of a fluid containing 50% trimethyl glycine on the corrosion of various metals determined as thinning thereof at 40° C. or below:

TABLE IIa

| | Copper, | Carbon steel | Brass, | Red metal, | Cast iron, |
|---|---|---|---|---|---|
| Fluid | μm/a | Fe52, μm/a | μm/a | μm/a | μm/a |
| 50% aqueous solution | 1.5 . . . 0.5 | 75 . . . 10 | 1.5 . . . 0.2 | 125 . . . 0.2 | 0.9 . . . 0.2 |
| of trimethyl glycine | | | | | |

Higher values show the corrosion rate at the beginning of the tests, lower values represent the situation stabilized with time.

Table IIb shows the effect of a fluid containing 35% trimethyl glycine on the corrosion of metals. Tap water and MEG 30% (ethylene glycol) and MPG 30% (propylene glycol) were used as reference materials. Corrosion tests were carried out according to the test ASTM 1384 at the temperature of 50° C. in a closed container of 500 ml.

TABLE IIb

| | | Cast | | | |
|---|---|---|---|---|---|
| Fluid | Fe37, | iron, | Copper, | Bronze, | Aluminium, |
| (without additives) | μm/a | μm/a | μm/a | μm/a | μm/a |
| MEG 30% | 51 | 69 | 0.6 | 1.4 | 4.8 |
| MPG 30% | 51 | 40 | 0.3 | 1.3 | 18 |
| Water | 68 | 95 | 1.6 | 1.7 | 18 |
| 35% aqueous solution | 27 | 61 | 1.4 | 1.9 | 10 |
| of trimethyl glycine | | | | | |
| 35% aqueous solution | 0.3 | 22 | 0.3 | 0.3 | 2.4 |
| of trimethyl glycine* | | | | | |

*= with commercial corrosion inhibitor

Table III below shows the effect of trimethyl glycine on freezing points of aqueous solutions.

TABLE III

| Fluid | Freezing point of a 50% solution, ° C. |
|---|---|
| Ethylene glycol | −35 |
| Propylene glycol | −34 |
| Trimethyl glycine | −35 |

The pH of the coolant fluid keeps always above 7 as trimethyl glycine itself is a buffering substance. Without any pH-adjusting additives the pH of the coolant typically ranges between 8 and 10, with additives it may range between 8-11.

The lubrication properties of the coolant fluid are significantly better than those of corresponding glycol based coolants. Further, the boiling point of the coolant fluid under normal pressure is well above 100° C., for example of a 50% trimethyl glycine solution it is 107-112° C. The coolant fluid also has excellent anti-freeze properties.

The coolant fluid gives very good results in glassware corrosion test, hot plate corrosion test and simulated corrosion test. The pH and reserve alkalinity keep in acceptable ranges and the coolant meets foaming requirements, particle counting requirements (class 11) and elastomer compatibility requirements. The cavitation corrosion test (Double chamber test) gives very good results with cast iron and aluminium.

The coolant fluid according to the invention can be used in various engine applications, such as engines commonly used in automobiles, trucks, motorcycles, aircrafts, trains, tractors, generators, compressors, in stationary engine and equipment applications, in marine engine applications, in power systems, in industrial engines, in electric engines, in fuel cell engines and in hybride engines and the like wherein cooling systems are used, and particularly in internal combustion engines in automobiles and in engines and water pumps with sensitive aluminium components. The coolant fluid is also particularly suitable for protection of equipment/engines under storage and warehousing.

The invention is illustrated in the following with examples. However, the scope of the invention is not limited to these examples.

### EXAMPLES

### Example 1

Lubrication Properties According to ISO 12156-1

Lubrication properties of aqueous solutions containing 40 wt-% and 50 wt-% of trimethyl glycine with commercial conventional inhibitor for engine coolants were compared with commercial engine coolant products containing propylene glycol and ethylene glycol using HFFR Lubrication test ISO 12156-1 at 25° C. The lower numerical value corresponds to better lubrication properties.

| Sample | Lubrication/μm |
|---|---|
| Trimethyl glycine 40 wt-%, additive 2-6 wt-% | 313-361 |
| Trimethyl glycine 50 wt-%, additive 2-6 wt-% | 285-305 |
| Propylene glycol 39.5 wt-%, containing additives | 346 |
| Propylene glycol 54.5 wt-%, containing additives | 348 |
| Ethylene glycol 37 wt-%, containing additives | 363 |
| Ethylene glycol 51.5 wt-%, containing additives | 326 |

### Example 2

Corrosion Test for Engine Coolants in Glassware According to ASTM D 1384

40 wt-% trimethyl glycine+3 wt-% commercial inhibitor (Chevron Texaco)

Mass change (mg/test specimen)

| Test specimen | Before treatment | After treatment |
|---|---|---|
| Copper | −0.2 | −0.9 |
| Solder | −4.3 | −5.7 |
| Brass | −1.2 | −2.0 |
| Steel | 0.8 | |
| Cast iron | 1.4 | |
| Cast aluminium | 13.0 | 10.1 |

| Coolant characteristics | Before test | After test |
|---|---|---|
| pH | 10.86 | 8.11 |
| Alkalinity reserve, ml HCl 0.1 M/ASTM D 1121 | 1.81 | 1.14 |
| Water content (%)/ASTM D 1744 | 55 | 56 |

### Example 3

Double Chamber Cavitation Corrosion Test According to CEC C-23-T-99

40 wt-% trimethyl glycine+3 wt-% commercial inhibitor (Chevron Texaco)

| | WEIGHT per SPECIMEN, mg | | | |
|---|---|---|---|---|
| | | After the test | | |
| | | and before | | |
| | Before | chemical | After chemical | Weight |
| SPECIMEN | the test | treatment | treatment | change |
| Cast Iron | M₁ | m₂ | | m₂ − m₁ |
| (FGL 200) | 137703.2 | 137698.1 | | −5.1 |
| Aluminium | M₁ | m₂ | m₃ | m₃ − m₁ |
| A-5S U3 Y30 | 50846.0 | 50854.2 | 50837.1 | −8.9 |

| DATA of the | Before | After |
|---|---|---|
| ENGINE COOLANT | TEST | TEST |
| pH | 10.86 | 8.50 |
| Reserve Alkalinity | 1.8 | 2.19 |
| Water Content, % | 60.6 | 58.7 |

### Example 4

Hot Plate Corrosion Test According to ASTM D 4340

40 wt-% trimethyl glycine+3 wt-% commercial inhibitor (Chevron Texaco)

A. Blanc test

| | Test tube mass (mg) | | |
|---|---|---|---|
| | Before preparation m₃ | After treatment m₄ | Change (m₄ − m₃) |
| Test tube 1 | 116524.3 | 116524.0 | 0.3 |
| Test tube 2 | 115428.6 | 115428.4 | 0.2 |
| Test tube 3 | 115248.5 | 115248.3 | 0.2 |
| Sum of the changes: | S (m4 − m3) | | 0.7 |
| Changes average m: | S (m4 − m3) | | 0.2 |

B. Corrosion speed

| | | |
|---|---|---|
| | | 30129 |
| Plate temperature | (° C.) | 135 |
| Liquid temperature | (° C.) | 130 |
| Pressure during the test | (pSi) | 28 |
| Mass before test (m₁) | (mg) | 107976.3 |
| Mass after test (m₂) | (mg) | 107970.0 |
| Mass change (m₁ − m₂) | (mg) | −6.3 |
| Blanc test m | (mg) | −0.2 |
| Area | (cm²) | 18.09 |
| Corrosion speed | (mg/cm² · week) | −0.34 |
| Quotation | | 4 |
| pH before test | | 10.86 |
| pH after test | | 8.97 |
| New or used metal specimen | | New |

### Example 5

Simulated Service Corrosion Test According to ASTM D 2570-96

40 wt-% trimethyl glycine+3 wt-% commercial inhibitor (Chevron Texaco)

Results:

| Measure | Before test | After test |
|---|---|---|
| PH | 10.85 | 8.00 |
| Alkalinity reserve (mg HCl 0.1 N) | 1.81 | 1.02 |
| Water content (%) | 60.5 | 60.0 |

TEST 1

| | Mass change (mg/test specimen) | | Test specimen |
|---|---|---|---|
| Test specimen | Before treatment | After treatment | appearance |
| Copper | +0.8 | −0.1 | 9 |
| Solder | −12.5 | −13.1 | 9 |
| Brass | −1.7 | −1.0 | 8 |
| Steel | −4.2 | | 9 |
| Cast iron | −7.0 | | 9 |
| Cast aluminium | +17.8 | +9.2 | 8 |

8 = Tarnished and slightly discoloured
9 = Slight and bright colour

TEST 2

| | Mass change (mg/test specimen) | | Test specimen |
|---|---|---|---|
| Test specimen | Before treatment | After treatment | appearance |
| Copper | +0.9 | −0.2 | 9 |
| Solder | −13.1 | −12.7 | 9 |
| Brass | −1.8 | −1.3 | 8 |
| Steel | −5.0 | | 9 |
| Cast iron | −7.4 | | 9 |
| Cast aluminium | +18.0 | +8.2 | 8 |

8 = Tarnished and slightly discoloured
9 = Slight and bright colour

TEST 3

| | Mass change (mg/test specimen) | | Test specimen |
|---|---|---|---|
| Test specimen | Before treatment | After treatment | appearance |
| Copper | +0.5 | −0.1 | 9 |
| Solder | −12.0 | −12.2 | 9 |
| Brass | −1.5 | −1.0 | 8 |
| Steel | −4.0 | | 9 |
| Cast iron | −6.2 | | 9 |
| Cast aluminium | +14.2 | +8.0 | 8 |

8 = Tarnished and slightly discoloured
9 = Slight and bright colour

AVERAGE

Mass change (mg/test specimen)

| Test specimen | Before treatment | After treatment |
|---|---|---|
| Copper | +0.7 | −0.2 |
| Solder | −12.5 | −12.7 |
| Brass | −1.6 | −1.1 |
| Steel | −4.4 | |
| Cast iron | −6.9 | |
| Cast aluminium | +16.7 | +8.5 |

### Example 6

Elastomer Compatibility Test According to MF T 46-013

40 wt-% trimethyl glycine+3 wt-% commercial inhibitor (Chevron Texaco), containing no elastomer protecting additives

| | | | | |
|---|---|---|---|---|
| Units | Elast. N^{o}1 | Elast. N^{o}2 | Elast. N^{o}3 | Results |

6A: Elastomer: RE 3 MVQ

| INITIAL | Length | cm | 75.00 | 75.00 | 75.00 | 75.00 |
|---|---|---|---|---|---|---|
| STATE | Width | cm | 13.00 | 13.00 | 13.00 | 13.00 |
| | Thickness | mm | 0.00 | 0.00 | 0.00 | 0.00 |
| | Load | g | 1.5801 | 1.6041 | 1.5455 | 1.5766 |
| | Hardness | Pts | 69 | 68 | 68.5 | 68.5 |
| | Stress break | Mpa | Average (5 tests) | | | 6.3 |
| | Strain break | % | Average (5 tests) | | | 151 |
| AFTER | Length | cm | 75.00 | 75.00 | 75.00 | 75.00 |
| AGEING | Width | cm | 13.00 | 13.00 | 13.00 | 13.00 |
| | Thickness | mm | 0.00 | 0.00 | 0.00 | 0.00 |
| | Load | g | 1.5974 | 1.6125 | 1.5593 | 1.5897 |
| | Hardness | Pts | 64 | 64 | 65 | 64.3 |
| | Stress break | Mpa | 5.0529 | 5.2927 | 5.6707 | 5.3 |
| | Strain break | % | 136.33 | 146.89 | 160.89 | 148 |
| VARIATION | Length | % | 0.0 | 0.0 | 0.0 | 0.0 |
| | Width | % | 0.0 | 0.0 | 0.0 | 0.0 |
| | Thickness | % | | | | |
| | Load | % | 1.1 | 0.5 | 0.9 | 0.8 |
| | Hardness | Pts | 1.5 | 0.7 | 0.9 | 1.0 |
| | Stress break | % | −4.5 | −4.5 | −3.5 | −4.2 |
| | Strain break | % | −20 | −16 | −10 | −15 |
| | | | −10 | −3 | 7 | −2 |

6B: Elastomer: RE 4 NBR

| INITIAL | Length | Cm | 75.00 | 75.00 | 75.00 | 75.00 |
|---|---|---|---|---|---|---|
| STATE | Width | cm | 13.00 | 13.00 | 13.00 | 13.00 |
| | Thickness | mm | 0.00 | 0.00 | 0.00 | 0.00 |
| | Load | g | 1.7109 | 1.6309 | 1.7163 | 1.6860 |
| | Hardness | Pts | 71 | 71.5 | 70.5 | 71.0 |
| | Stress break | Mpa | Average (5 tests) | | | 22.8 |
| | Strain break | % | Average (5 tests) | | | 405 |
| AFTER | Length | cm | 75.00 | 75.00 | 758.00 | 302.67 |
| AGEING | Width | cm | 13.00 | 13.00 | 13.00 | 13.00 |
| | Thickness | mm | 0.00 | 0.00 | 0.00 | 0.00 |
| | Load | g | 1.7262 | 1.6466 | 1.7321 | 1.7016 |
| | Hardness | Pts | 69 | 70 | 68 | 69.0 |
| | Stress break | Mpa | 24.075 | 24.416 | 25.115 | 24.5 |
| | Strain break | % | 349.99 | 359.65 | 372.17 | 361 |
| VARIATION | Length | % | 0.0 | 0.0 | 910.7 | 303.6 |
| | Width | % | 0.0 | 0.0 | 0.0 | 0.0 |
| | Thickness | % | | | | |
| | Load | % | 0.9 | 1.0 | 0.9 | 0.9 |
| | Hardness | Pts | 0.4 | 1.2 | 1.1 | 0.9 |
| | Stress break | % | −2.0 | −1.0 | −3.0 | −2.0 |
| | Strain break | % | 6 | 7 | 10 | 8 |
| | | | −14 | −11 | −8 | −11 |

6C: Elastomer: EDPM LS1

| INITIAL | Length | Cm | 75.00 | 75.00 | 75.00 | 75.00 |
|---|---|---|---|---|---|---|
| STATE | Width | cm | 13.00 | 13.00 | 13.00 | 13.00 |
| | Thickness | mm | 0.00 | 0.00 | 0.00 | 0.00 |
| | Load | g | 1.5225 | 1.5041 | 1.5719 | 1.5328 |
| | Hardness | Pts | 63 | 63.5 | 63 | 63.2 |
| | Stress break | Mpa | Average (5 tests) | | | 17.9 |
| | Strain break | % | Average (5 tests) | | | 304 |
| AFTER | Length | cm | 75.00 | 75.00 | 75.00 | 75.00 |
| AGEING | Width | cm | 13.00 | 13.00 | 13.00 | 13.00 |
| | Thickness | mm | 0.00 | 0.00 | 0.00 | 0.00 |
| | Load | g | 1.5313 | 1.5132 | 1.5830 | 1.5425 |
| | Hardness | Pts | 59 | 60 | 58 | 59.0 |
| | Stress break | Mpa | 12.132 | 16.106 | 15.877 | 14.7 |
| | Strain break | % | 219.03 | 263.4 | 281.94 | 255 |
| VARIATION | Length | % | 0.0 | 0.0 | 0.0 | 0.0 |
| | Width | % | 0.0 | 0.0 | 0.0 | 0.0 |
| | Thickness | % | | | | |
| | Load | % | 0.6 | 0.6 | 0.7 | 0.6 |
| | Hardness | Pts | 1.0 | 0.6 | 0.7 | 0.8 |
| | Stress break | % | −4.2 | −3.2 | −5.2 | −4.2 |
| | Strain break | % | −32 | −10 | −11 | −18 |
| | | | −28 | −13 | −7 | −16 |

### Example 7

High Temperature Stability Test of Engine Coolants According to CEC C-21-T-00

40 wt-% trimethyl glycine+3 wt-% commercial inhibitor (Chevron Texaco)

| RESULTS: | Container wall corrosion | dull and slightly | |
|---|---|---|---|
| | Evaluate the corrosion | coloured (8); high | |
| | type (general or at the | colouring at the | |
| | liquid level) | interface liquid/air | |
| | Deposits content after | 1 ml | |
| | decantation (ml) | | |
| | Liquid coloration | Dark Brown | |
| | after test | | |
| SUPPLEMENTARY | | | Pressure |
| REMARKS | | | 390 kPa |

[image]

### Example 8

Kinematic Viscosity According to ASTM D 445

40 wt-% trimethyl glycine+3 wt-% commercial inhibitor (Chevron Texaco)

| Temperature (° C.) | Viscosity (mm²/sec) |
|---|---|
| 100 | 0.89 |
| 40 | 2.37 |
| 20 | 4.02 |
| 0 | 8.07 |
| −20 | 20.57 |

[image]

### Example 9

Oxidation Stability Test According to ASTM D 943

40 wt-% trimethyl glycine+3 wt-% commercial inhibitor (Chevron Texaco)

Test conditions:

300 ml oil;

95° C.±0.2° C.;

3 l O₂/h±0.1 l/h;

Iron/copper spiral.

Results:

| Hours | TAN (mg KOH/g) |
|---|---|
| 0 | 0.01 |
| 168 | 0.14 |
| 336 | 0.25 |
| 504 | 0.46 |
| 672 | 0.67 |
| 840 | 0.75 |
| 1008 | 0.73 |
| 1176 | 0.80 |
| 1344 | 1.22 |
| 1512 | 3.65 |

### Example 10

4 Balls Test According to IP 239 (Lubrication)

40 wt-% trimethyl glycine+3 wt-% commercial inhibitor (Chevron Texaco)

| LOAD | WEAR DIAMETER (mm) | | | | | | Average wear | Factor | Corrected | Comp. |
|---|---|---|---|---|---|---|---|---|---|---|
| (kg) | 1 | 2 | 3 | 4 | 5 | 6 | diameter | LDₕ | load (kg) | lig. (mm) |
| 6 | | | | | | | | 0.95 | | |
| 8 | | | | | | | | 1.40 | | |
| 10 | | | | | | | | 1.88 | | 0.21 |
| 13 | | | | | | | | 2.67 | | 0.23 |
| 16 | | | | | | | | 3.52 | | 0.25 |
| 20 | | | | | | | | 4.74 | | 0.27 |
| 24 | 0.14 | 0.35 | 0.14 | 0.38 | 0.24 | 0.33 | 0.26 | 6.05 | 23.3 | 0.28 |
| 32 | 0.32 | 0.40 | 0.30 | 0.38 | 0.33 | 0.35 | 0.35 | 8.87 | 25.3 | 0.31 |
| 40 | 0.40 | 0.52 | 0.41 | 0.49 | 0.40 | 0.49 | 0.45 | 11.96 | 26.6 | 0.33 |
| 50 | 0.46 | 0.51 | 0.44 | 0.54 | 0.44 | 0.49 | 0.48 | 16.10 | 33.5 | 0.36 |
| 63 | 0.66 | 0.84 | 0.68 | 0.74 | 0.68 | 0.84 | 0.74 | 21.86 | 29.5 | 0.39 |
| 80 | 1.26 | 1.30 | 1.25 | 1.28 | 1.24 | 1.29 | 1.27 | 30.08 | 23.7 | 0.42 |
| 100 | 1.68 | 1.72 | 1.72 | 1.72 | 1.60 | 1.68 | 1.69 | 40.5 | 24.0 | 0.46 |
| 126 | 2.04 | 2.20 | 2.08 | 2.16 | 2.12 | 2.28 | 2.15 | 55.2 | 25.7 | 0.50 |
| 160 | WELDING | | | | | | | 75.8 | | 0.54 |
| 200 | | | | | | | | 102.2 | | 0.59 |
| 250 | | | | | | | | 137.5 | | |
| 315 | | | | | | | | 187.1 | | |
| 400 | | | | | | | | 258 | | |
| 500 | | | | | | | | 347 | | |
| 620 | | | | | | | | 462 | | |
| 800 | | | | | | | | 649 | | |

1. Use of an aqueous solution comprising trimethyl glycine as a coolant fluid and/or as a protective fluid in engine applications.

2. Use according to claim 1, characterized in that the engine applications are selected from engines used in automobiles, trucks, motorcycles, aircrafts, trains, tractors, generators, compressors, from stationary engines and equipment, marine engines, power systems, industrial engines, electric engines, fuel cell engines and hybride engines.

3. Use according to claim 1 or 2, characterized in that the engine applications are selected from internal combustion engines used in automobiles.

4. Use according to claim 1, characterized in that the engine applications are selected from engines and water pumps with aluminium components.

5. Use according to claim 1, characterized in that the coolant fluid comprises 1 to 60% by weight of trimethyl glycine as an anhydrate or monohydrate, or salts or derivatives of trimethyl glycine or mixtures thereof.

6. Use according to claim 1, characterized in that the coolant fluid comprises 20 to 45% by weight of trimethyl glycine as an anhydrate or monohydrate, or salts or derivatives of trimethyl glycine or mixtures thereof.

7. Use according to any one of claims 1-6 claim 1, characterized in that the coolant comprises additives.
